(19) United States
(12) Patent Application Publication
(10) Pub. No.: US 2010/0173150 A1
(43) Pub. Date: Jul. 8, 2010

(54) METHOD FOR FITTING AND PROTECTING A SENSOR ON A SUBSTRATE

(75) Inventors: Charly BULEON, Melun (FR); Frédéric Leman, Montrouge (FR); Etienne Tulie, Soisy Sur Seine (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SNECMA, Paris (FR)

(21) Appl. No.: 12/571,858

(22) Filed: Oct. 1, 2009

(30) Foreign Application Priority Data
Oct. 24, 2008 (FR) 08 05927

(51) Int. Cl. B05D 3/06; B32B 9/00

(52) U.S. Cl. 428/336; 427/554

(57) ABSTRACT

The method consists in depositing, by alumina spraying, an electrically insulating sublayer on the substrate, then in placing the sensor on the electrically insulating sublayer and finally in depositing, by alumina spraying, a cover layer on the sensor and the electrically insulating sublayer. It further includes a step of densifying, by localized remelting, of the alumina coating on the surface of the cover layer.

### BACKGROUND OF THE INVENTION

The present invention relates to a method for fitting and protecting a sensor on a substrate intended to be subjected to high temperatures, for example above 900° C., such as a turbomachine part.

The invention applies in particular to stationary parts (for example parts of combustion chambers) or to rotating parts (for example high-pressure and low-pressure turbine blades) which are subjected to high centrifugal forces coming from being rotated at high speed (around 20 000 rpm).

In the context of developing new turbojets and the certification thereof by the authorities, trials to be conducted require the bonding of sensors, such as strain gauges or thermocouples, for monitoring the mechanical and thermal behavior of the hot parts of the turbomachine. The sensors must be fixed onto the substrate and protected.

### DESCRIPTION OF THE PRIOR ART

A known method of fitting a high-temperature strain gauge on turbomachine parts, described in patent application FR 2 909 759 in the name of the Applicant, consists essentially in depositing, by alumina flame spraying, an electrically insulating sublayer on the substrate intended to bear the gauge, then in placing the gauge on the electrically insulating sublayer and finally in depositing, by alumina flame spraying, a cover layer on the gauge and the electrically insulating sublayer.

Above 900° C., under trial conditions (namely with oil, kerosene and combustion gases), the alloy of commercially available gauges is strongly oxidized.

This is because, owing to the flame spraying, the alumina layers have a porous coarse-grained structure, which gives the coating a ductility suitable for hot deformation of the instrumented parts.

However, micrograph sections taken on a gauge after a trial have shown stronger oxidation of the sensor wires close to the interconnected microcracks and pores (and those emerging on the surface) of the alumina coating.

The increase in resistance due to this oxidation has been estimated at nearly 15%, which may result during the trial in an error of the same order of magnitude on the measurement.

In addition, the mechanical resistance of the gauge to vibratory stresses is also reduced, thereby limiting its lifetime.

Now, in current turbo-engines the temperatures are becoming higher and higher, and a turbo-engine certification campaign may be jeopardized should a substantial number of strain gauges or thermocouples be lost, and this may incur substantial financial losses because of delays to the program or penalties.

The aim of the present invention is to avoid these drawbacks by increasing the lifetime of the sensors and limiting the drift in their electrical properties during high-temperature trials.

### SUMMARY OF THE INVENTION

For this purpose, one subject of the invention is a method for fitting and protecting a sensor on a substrate, which consists in depositing, by alumina spraying, an electrically insulating sublayer on said substrate, then in placing the sensor on said electrically insulating sublayer and finally in depositing, by alumina spraying, a cover layer on the sensor and the electrically insulating sublayer, said method being noteworthy in that it further includes a step of densifying, by localized remelting, of the alumina coating on the surface of the cover layer over the first microns in thickness.

Thus, the inventive notion consists in modifying the surface porosity of the alumina cover layer, by making the surface of the cover layer impermeable so as to prevent the oxidizing atmosphere from reaching the wires of the sensor.

The densifying operation is for example a laser densification, the fluence of said laser being determined so as to act only over the first microns in thickness starting from the surface of the cover layer.

Another subject of the invention is a turbomachine part provided with at least one sensor fitted by this method.

### DESCRIPTION OF THE DRAWINGS

The invention will be better understood and other advantages thereof will become more clearly apparent in the light of the description of an embodiment, given by way of nonlimiting example and with reference to the appended drawings in which:

FIG. 1 is a schematic view showing, in cross section, a turbomachine part provided with a strain gauge fitted by a method according to the invention; and
FIG. 2 is an enlarged view of a detail of FIG. 1.

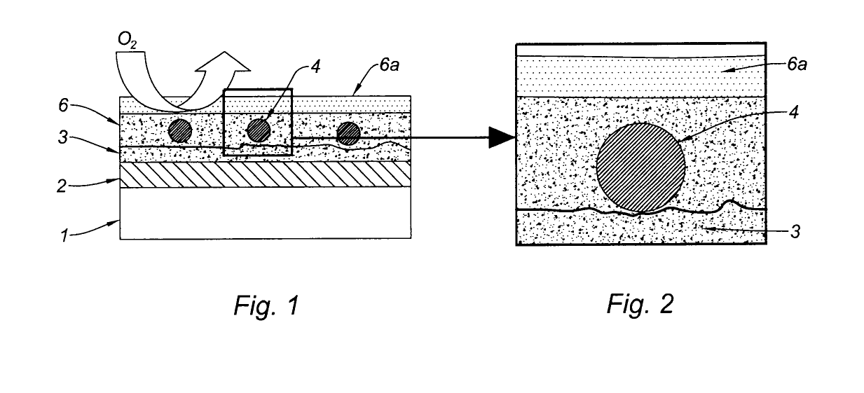

### DESCRIPTION OF THE PREFERRED EMBODIMENT

FIG. 1 shows a surface 1 of a turbomachine part (not shown), such as a rotating turbine blade made of a nickel superalloy (of any known type).

As described in patent application FR 2 909 759 in the name of the Applicant, the surface 1 was surmounted by a tie sublayer 2 of NiCrAIY alloy (22% chromium, 10% aluminum and 1.0% yttrium) so as to promote adhesion of an electrically insulating alumina sublayer 3 to which a strain gauge, illustrated by the section of its wires 4, was affixed, the whole assembly being covered with an alumina cover layer 6.

The alumina layers 3 and 6 were deposited by an oxyacetylene flame spraying method, while the alloy tie sublayer 2 was deposited by a plasma spraying method in an atmosphere so as to obtain a coating with 5 to 10% less porosity than that using flame spraying.

The invention differs from this known technique in that the method further includes a step of densifying, by localized remelting, of the alumina coating 6a on the surface of the cover layer 6.

This is a laser densification, the fluence of said laser being predetermined so as to act only over the first microns in thickness starting from the surface 6a of the cover layer 6, without reaching the gauge, so as to impair as little as possible the overall porosity of the coating (through the thickness), while still making its surface impermeable. One desirable feature is in fact a high porosity in order to obtain a ductile and robust coating when subjected to mechanical stresses.

This renders the surface 6a of the alumina cover layer 6 impermeable and prevents the oxidizing atmosphere from reaching the wires 4 of the gauge.

The invention thus makes it possible to increase the lifetime of the sensors and reduce the drift in their electrical characteristics during trials at above 900° C.

1. A method for fitting and protecting a sensor on a substrate intended to be subjected to high temperatures, above 900° C., which consists in depositing, by alumina spraying, an electrically insulating sublayer on said substrate, then in placing the sensor on said electrically insulating sublayer and finally in depositing, by alumina spraying, a cover layer on the sensor and the electrically insulating sublayer, which method further includes a step of densifying, by localized remelting, of the alumina coating on the surface of the cover layer, over the first microns in thickness.

2. The method for fitting and protecting a sensor as claimed in claim 1, wherein the densifying operation is a laser densification, the fluence of said laser being determined so as to act only over the first microns in thickness starting from the surface of the cover layer.

3. A turbomachine part provided with at least one sensor fitted by a method as claimed in either one of claims 1 and 2.
